(19) United States
(12) Patent Application Publication
(10) Pub. No.: US 2005/0145055 A1
(43) Pub. Date: Jul. 7, 2005

(54) Shift lever assembly

(76) Inventor: Ian John Byles, Victoria (AU)

Correspondence Address: STITES & HARBISON PLLC, 1199 NORTH FAIRFAX STREET, SUITE 900, ALEXANDRIA, VA, 22314, US

(21) Appl. No.: 11/012,721

(22) Filed: Dec. 16, 2004

(30) Foreign Application Priority Data
Dec. 16, 2003 (AU) 2003906978

(51) Int. Cl. F16H 59/00

(52) U.S. Cl. 74/473.21; 74/473.33; 74/473.18

(57) ABSTRACT

A shift lever assembly (10) including a base member (14) and a shift lever (12). The shift lever (12) is pivotally mounted to the base member (14) and includes first and second shift lever shifting paths (18,20). The shift lever (12) is movable by an operator along a changeover path between the first and second shifting paths (18,20). The shift lever (12) is also movable by an operator along the first shifting path (18) from an initial position to at least one further position relative to the base member (14). An actuator (26) is pivotally mounted to the base member (14). The actuator (26) is configured for movement along the first shifting path (18) between the initial position and the at least one further position. The shift lever (12) engages the actuator (26) when in the first shifting path (18), such that movement of the shift lever (12) by an operator between the initial position and the at least one further position moves the actuator (26) between the initial position and the at least one further position. The assembly (10) includes an actuator movement restriction device (56). With the shift lever (12) in the second shifting path (20), the movement restriction device (56) restricts movement of the actuator (26) between the initial position and the at least one further position.

### FIELD OF THE INVENTION

The present invention relates broadly to a shift lever assembly for a vehicle transmission. The present invention particularly relates to a shift lever assembly for enabling a driver to select either an automatic shift mode or a manual shift mode, and is herein generally described in that context. However, it will be appreciated that the invention has broader application and is not limited to that particular use.

### BACKGROUND OF THE INVENTION

Shift lever assemblies of the type mentioned in the previous paragraph generally include two shift lever shifting paths. The first shifting path is provided for the automatic shift mode, allowing for the pre-selection of any one of, for example, a park (P) position, a reverse (R) position, a neutral (N) position, and at least one drive range (D) position.

The second shifting path is provided for the manual shift mode, and includes three positions in which the shift lever can adopt a neutral (or centre) position, an up-shift position and a down-shift position. In the second shifting path, the shift lever is shifted to the up-shift position from the neutral position to shift one gear up in the vehicle automatic transmission. Similarly, the shift lever is shifted from the neutral position to the down-shift position to shift one gear down.

In one form, the first and second shifting paths are arranged adjacent and generally parallel to one another. It is to be appreciated, however, that either or both of the first and second shifting paths need not be straight. One or both of the paths may be provided in a stepped pattern.

A changeover path is generally provided and connects the first and second shifting paths to one another, allowing for the shift lever to be moved between the first and second shifting paths.

Typically, the first shifting path is linked to a mechanical gear selecting mechanism and the second shifting path is linked to a non-mechanical (for example, electrical) gear selecting mechanism.

Existing assemblies often include a safety (or locking) mechanism to prevent the inadvertent changing of transmission gears using the mechanical gear selecting mechanism of the automatic shift mode when the assembly is in the manual shift mode. These safety mechanisms generally function satisfactorily. However, they are relatively complex in design, and undesirably require additional assembly components.

It would therefore be desirable to provide a shift lever assembly of simplified construction when compared to existing shift lever assemblies. In particular, it would be desirable to provide a simplified safety mechanism of the sort referred to in the previous paragraph.

### SUMMARY OF THE INVENTION

According to one aspect of the present invention, there is provided a shift lever assembly comprising a base member and a shift lever. The shift lever is pivotally mounted to the base member and includes first and second shift lever shifting paths. The shift lever is movable by an operator along a changeover path between the first and second shifting paths. The shift lever is also movable by an operator along the first shifting path from an initial position to at least one further position relative to the base member. An actuator is pivotally mounted to the base member. The actuator is configured for movement along the first shifting path between the initial position and the at least one further position. The shift lever engages the actuator when in the first shifting path, such that movement of the shift lever by an operator between the initial position and the at least one further position moves the actuator between the initial position and the at least one further position. The assembly comprises an actuator movement restriction device. With the shift lever in the second shifting path, the movement restriction device restricts movement of the actuator between the initial position and the at least one further position. The movement restriction device and the shift lever are integrally formed.

Integral formation of the movement restriction device and the shift lever simplifies the assembly when compared to existing arrangements.

In one form, the first shifting path is provided for the automatic shift mode, allowing for the pre-selection of any one of, for example, a park (P) position, a reverse (R) position, a neutral (N) position, and at least one drive range (D) position. The second shifting path is provided for the manual shift mode, and may include three positions in which the shift lever can adopt a neutral (or centre) position, an up-shift position and a down-shift position. Alternatively, the second shifting path may include additional positions for the selection of gears.

The actuator and the shift lever may be coaxially pivotally mounted to the base member. Indeed, a common axle or pin may mount the actuator and the shift lever to the base member.

The actuator preferably includes a connection point for a transmission actuation cable, thereby providing a means for actuating the vehicle transmission when the shift lever is in the automatic shift mode.

A plurality of pre-defined actuator positions may be provided relative to the base member, corresponding to the automatic shift mode pre-selection positions of a park (P) position, a reverse (R) position, a neutral (N) position, and at least one drive range (D) position.

A positive shift lever feel for the operator may accompany engagement of each of the pre-defined actuator positions. The pre-defined actuator positions and positive shift lever feel may be provided by a series of detents provided along an actuator surface. Each of the detents may by separately engageable by a detent engager mounted on the base member. The detent engager may be of any practical form, and in one form is a leaf spring, having a detent engagement end and a base member mounting end.

It is to be appreciated that, in an alternative arrangement, the series of detents may be provided on the base member and the detent engager may be mounted on the actuator.

In a preferred form, the movement restriction device comprises a lug (or arm) integrally formed on the shift lever. With the shift lever in the manual mode, the lug locates immediately behind the detent engagement end of the leaf spring to prevent the engagement end moving to another detent. In this way, the inadvertent actuator selection of another automatic shift mode (when the shift lever is in the manual shift mode) is prevented.

Integration of the shift lever and the movement restriction means provides the advantage of a greatly simplified design when compared to existing arrangements.

The assembly may include a switching means mounted to the base member for generating an operating signal in response to pivotal movement of the shift lever relative to the base member when in the manual shift mode.

The switching means may be provided in a module (or unit) and may be mounted to the base member in a desired position.

The switching means may adopt any practical form. In a preferred form, the switching means includes an electromechanical switch.

It will be convenient to hereinafter describe a preferred embodiment of the invention with reference to the accompanying drawings. The particularity of the drawings is to be understood as not limiting the preceding broad description of the invention.

### BRIEF DESCRIPTION OF THE DRAWINGS

In the drawings:

FIG. 1 is a side view of internal componentry of a shift lever assembly according to one aspect of the present invention when in the automatic shift mode.

FIG. 2 is a front view of the shift lever assembly componentry of FIG. 1 when in the neutral position in the manual shift mode.

FIG. 3 is a perspective side view of the shift lever assembly componentry as illustrated in FIG. 2.

FIG. 4 is a perspective side view of the shift lever assembly componentry when in the down-shift position in the manual shift mode.

FIG. 5 is another perspective side view of the shift lever assembly componentry as illustrated in FIG. 4.

FIG. 6 is a perspective side view of the shift lever assembly componentry when in the up-shift position in the manual shift mode.

FIG. 7 is a perspective rear view of the shift lever assembly componentry as illustrated in FIG. 6.

### DESCRIPTION OF A PREFERRED EMBODIMENT

Referring to the Figures, there is illustrated some of the internal componentry of a shift lever assembly 10. The assembly 10 is configured for use in a right-hand drive vehicle. The shift lever assembly 10 includes a shift lever 12 and a base member 14. Fasteners (not illustrated) secure the base member 14 for use to a vehicle floor (not illustrated).

The shift lever 12 includes (and is pivotally movable relative to the base member 14 by way of) a first pivot shaft 18 and a second pivot shaft 20.

The first pivot shaft 18 extends in the transverse direction of the vehicle and permits movement of the shift lever 12 in the longitudinal direction of the vehicle along either a first shifting path for the automatic shift mode, or a second shifting path for the manual shift mode.

The second pivot shaft 20 extends in the longitudinal direction of the vehicle. The shaft 20 enables the shift lever 12 to pivot in the transverse direction of the vehicle along a changeover path, from the first shifting path, to the second shifting path, and return.

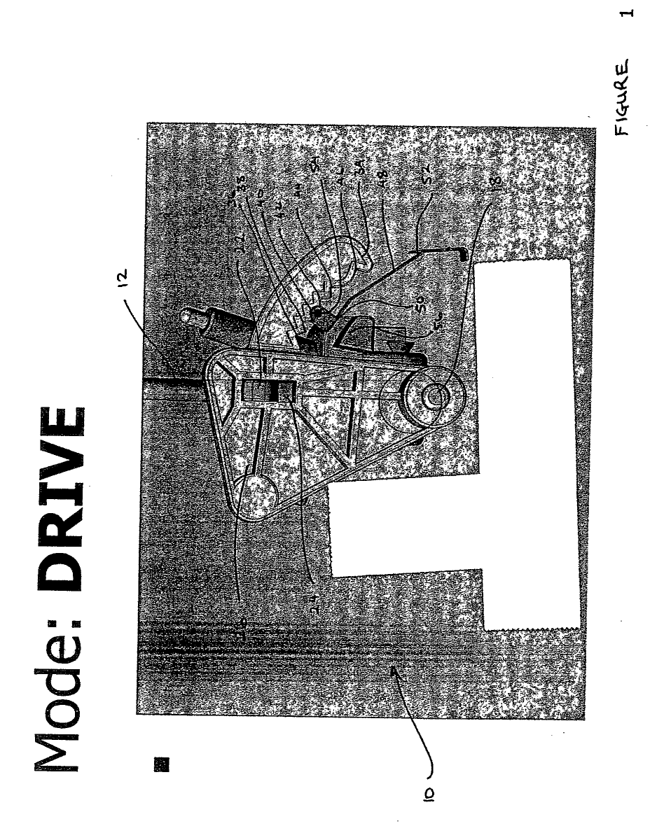

FIG. 1 illustrates the shift lever 12 in the automatic shift mode, allowing the operator (typically a vehicle driver) to pre-select the transmission position. In this mode, and by pivoting the shift lever 12 about the first pivot shaft 18, a range of transmission positions may be selected by the vehicle driver. These positions include: a park (P) position, a reverse (R) position, a neutral (N) position, a drive (D) position, a 1^{st} drive gear (D1) position, and a 2^{nd} drive gear (D2) position.

The shift lever 12 includes an arm 22. When the shift lever 12 is in the automatic shift mode, the arm 22 is received in an aperture 24 provided in a transmission actuator 26. Like the shift lever 12, the actuator 26 is pivotally mounted to the base member 14 by the first pivot shaft 18. With the shift lever 12 in the automatic shift mode (and with the arm 22 received in actuator aperture 24), movement of the shift lever 12 between the various automatic mode driving positions moves the actuator 26 about the shaft 18 in tandem with the shift lever 12. The actuator 26 includes a cable mount 28, with a cable (not illustrated) provided for mechanically actuating the vehicle transmission in response to movement of the shift lever 12 when in the automatic shift mode.

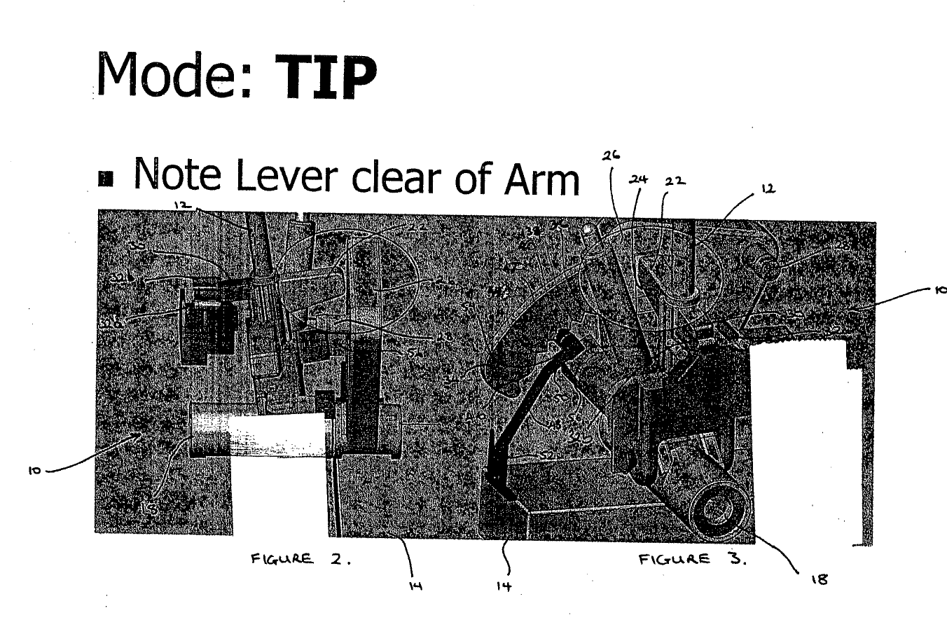

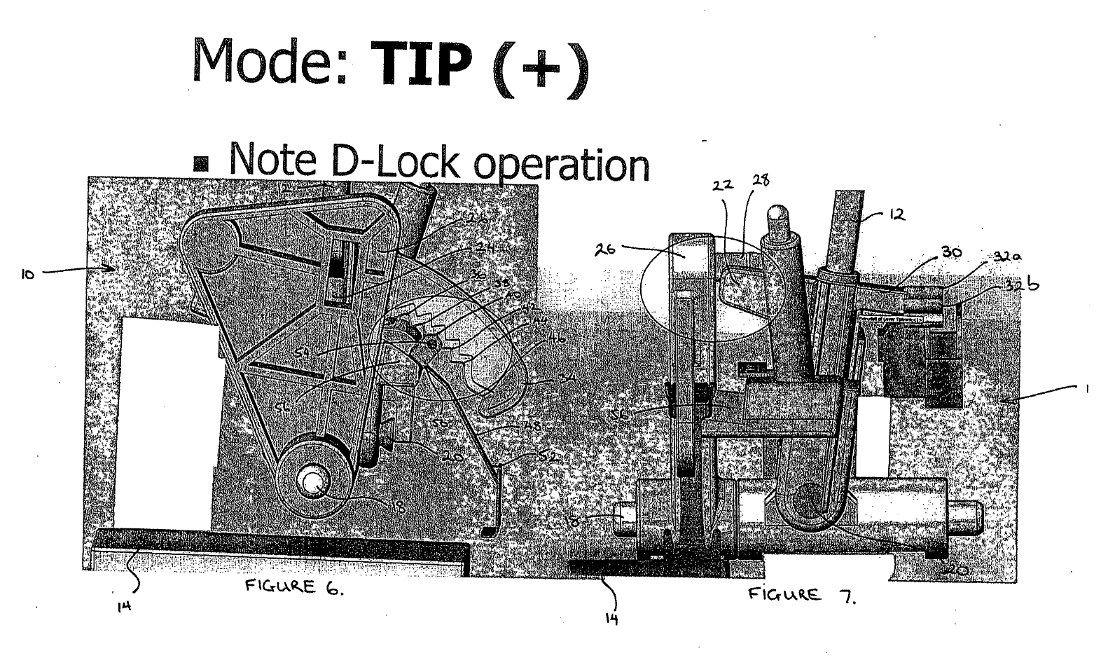

FIGS. 2 to 7 illustrate the shift lever 12 when in the manual shifting mode. It should be noted that the arm 22 is clear of the aperture 24 in FIGS. 2 to 7 when the shift lever 12 is in the manual shift mode. Shifting of the shift lever 12 in the driving direction of the vehicle causes an up-shift (as illustrated in FIGS. 6 and 7) by one gear in the automatic transmission. Subsequently, the shift lever 12 is automatically set back into the neutral position (as illustrated in FIGS. 2 and 3) of the manual shift mode by a biasing means, such as a spring (not illustrated).

If the shift lever 12 is again moved in the driving direction of the vehicle, a further up-shift (again, as illustrated in FIGS. 6 and 7) by one gear in the automatic transmission will occur, unless the highest gear is already engaged, whereupon the shift lever 12 is again automatically returned to the neutral position.

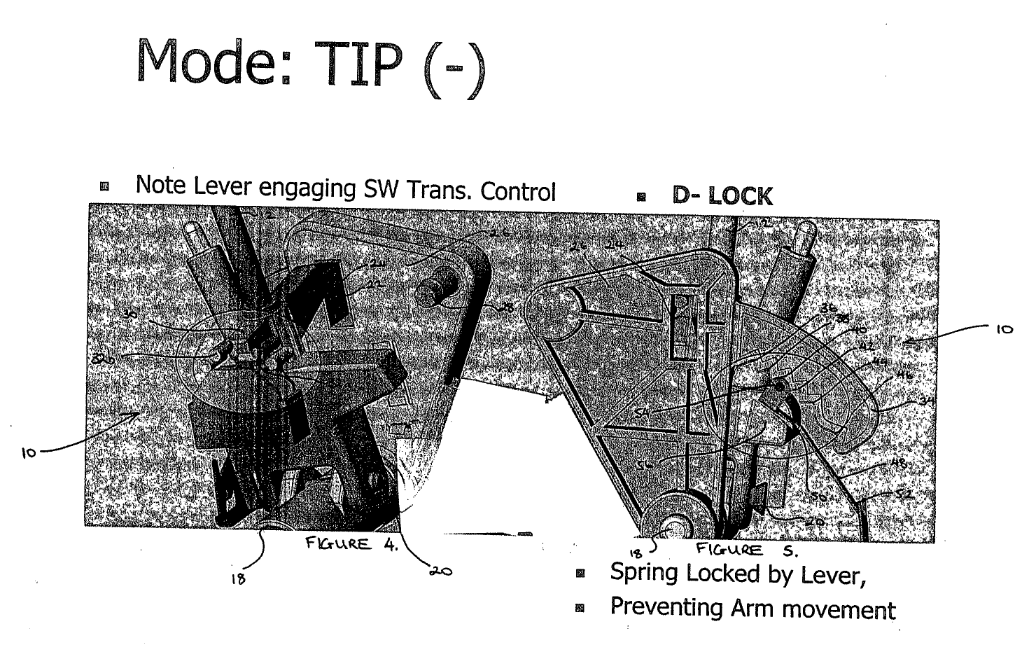

Shifting of the shift lever 12 in a direction opposite to the vehicle driving position, when in the manual shift mode, causes a down-shift (as illustrated in FIGS. 4 and 5) by one gear of the automatic transmission, whereupon the shift lever 12 is again automatically returned to the neutral position.

The shift lever 12 includes a switch arm 30 for actuating switches 32a,b when in the manual shift mode. Switch 32a generates an operating signal in response to the operator up-shifting the shift lever 12 when in the manual shifting mode. Switch 32b generates an operating signal in response to the operator down-shifting the shift lever 12 when in the manual shifting mode.

The actuator 26 includes an integrally formed arm 34 which, with the assembly 10 mounted in a vehicle, extends in the longitudinal direction of the vehicle. The arm 34 includes a series of detents 36,38,40,42,44,46. A detent engager, in the form of a leaf spring 48 is provided. The spring 48 includes a detent engagement end 50 and an end 52 mounted to the base member 14. The detent end 50 includes a roller follower 54. Each of the detents is separately engaged by the follower 54 upon movement of the shift lever 12 (and, hence, also the actuator 26) in the automatic shifting mode. The detent 36 defines the pre-selected drive range (D) position; the detent 38 defines the pre-selected 1^{st} drive gear (D1) position; the detent 40 defines the pre-selected 2^{nd} drive gear (D2) position; the detent 42 defines the pre-selected neutral (N) position; the detent 44 defines the pre-selected reverse (R) position; and the detent 46 defines the pre-selected park (P) position.

An actuator movement restriction device (or lock mechanism) is provided. The movement restriction device includes a lug 56, which is integrally mounted on the shift lever 12. Integration of the shift lever 12 and the lug 56 provides a greatly simplified arrangement when compared to existing arrangements. When the shift lever 12 is in the automatic shift mode, as illustrated in FIG. 1, the lug 56 does not hinder movement of the follower 54 between detents upon the vehicle driver pre-selecting a transmission mode.

However, as illustrated in FIGS. 2 to 7, with the shift lever in the manual shifting mode, the lug 56 locates immediately behind the follower 54, thereby preventing the follower 54 moving downwardly. In turn, this prevents the follower 54 from moving between detents 36-46 and undesirably manually selecting a transmission mode.

It is to be appreciated that any practical substitute for the spring 48 may be adopted, if desired. Further, the spring 48 need not include a follower 54.

The arrangement illustrated provides the detents 36-46 on the actuator 26, with the spring 48 mounted on the base member 14. It is to be appreciated, however, that the detents 36-46 may be provided on the base member 14 and the spring 48 may be mounted on the actuator 26.

The present invention advantageously prevents movement of the assembly actuator 26 when the assembly 10 is operating in the manual shifting mode. Moreover, the present invention achieves this without the need for additional assembly components.

Finally, it is to be understood that various alterations, modifications and/or additions may be introduced into the construction and arrangement of the parts previously described without departing from the spirit or ambit of this invention.

1. A shift lever assembly comprising:
a base member;
a shift lever; the shift lever being pivotally mounted to the base member and comprising first and second shift lever shifting paths;
the shift lever being movable by an operator along a changeover path between the first and second shifting paths;
the shift lever also being movable by an operator along the first shifting path from an initial position to at least one further position relative to the base member;
an actuator, the actuator being pivotally mounted to the base member and moveable along the first shifting path between the initial position and the at least one further position;
the shift lever engaging the actuator when in the first shifting path, such that movement of the shift lever by an operator between the initial position and the at least one further position moves the actuator between the initial position and the at least one further position;
an actuator movement restriction device; wherein with the shift lever in the second shifting path, the movement restriction device restricts movement of the actuator between the initial position and the at least one further position;
the movement restriction device and the shift lever being integrally formed;
the first shifting path being provided for the automatic shift mode, allowing for the pre-selection of any one of, for example, a park (P) position, a reverse (R) position, a neutral (N) position, and at least one drive range (D) position;
the second shifting path being provided for the manual shift mode;
a plurality of pre-defined actuator positions being provided relative to the base member, corresponding to the automatic shift mode pre-selection positions of the park (P) position, the reverse (R) position, the neutral (N) position, and the at least one drive range (D) position;
a positive shift lever feel for the operator accompanying engagement of each of the pre-defined actuator positions;
the pre-defined actuator positions and positive shift lever feel being provided by a series of detents provided along an actuator surface;
each of the detents being separately engageable by a detent engager mounted on the base member, the detent engager comprising a leaf spring having a detent engagement end and a base member mounting end; and
the movement restriction device including a lug or arm integrally formed on the shift lever such that, with the shift lever in the manual mode, the lug locates immediately behind the detent engagement end of the leaf spring to prevent the engagement end moving to another detent.

2. A shift lever assembly comprising:
a base member;
a shift lever; the shift lever being pivotally mounted to the base member and comprising first and second shift lever shifting paths;
the shift lever being movable by an operator along a changeover path between the first and second shifting paths;
the shift lever also being movable by an operator along the first shifting path from an initial position to at least one further position relative to the base member;
an actuator, the actuator being pivotally mounted to the base member and moveable along the first shifting path between the initial position and the at least one further position;
the shift lever engaging the actuator when in the first shifting path, such that movement of the shift lever by an operator between the initial position and the at least one further position moves the actuator between the initial position and the at least one further position; and
an actuator movement restriction device wherein, with the shift lever in the second shifting path, the movement restriction device restricts movement of the actuator between the initial position and the at least one further position; and
the movement restriction device and the shift lever being integrally formed.

3. A shift lever assembly according to claim 2, wherein the first shifting path is provided for the automatic shift mode, allowing for the pre-selection of any one of, for example, a park (P) position, a reverse (R) position, a neutral (N) position, and at least one drive range (D) position; and the second shifting path is provided for the manual shift mode.

4. A shift lever assembly according to claim 3, wherein the manual shift mode comprises three positions in which the shift lever may adopt a neutral, centre position, an up-shift position and a down-shift position.

5. A shift lever assembly according to claim 2, wherein the actuator and the shift lever are coaxially pivotally mounted to the base member.

6. A shift lever assembly according to claim 5, wherein one of a common axle and a common pin is provided for mounting the actuator and the shift lever to the base member.

7. A shift lever assembly according to claim 3, wherein the actuator includes a connection point for a transmission actuation cable, thereby providing a means for actuating the vehicle transmission when the shift lever is in the automatic shift mode.

8. A shift lever assembly according to claim 3, wherein a plurality of pre-defined actuator positions are provided relative to the base member, corresponding to the automatic shift mode pre-selection positions of the park (P) position, the reverse (R) position, the neutral (N) position, and the at least one drive range (D) position.

9. A shift lever assembly according to claim 8, wherein a positive shift lever feel for the operator accompanies engagement of each of the pre-defined actuator positions.

10. A shift lever assembly according to claim 9, wherein the pre-defined actuator positions and positive shift lever feel are provided by a series of detents provided along an actuator surface.

11. A shift lever assembly according to claim 10, wherein each of the detents are separately engageable by a detent engager mounted on the base member.

12. A shift lever assembly according to claim 11, wherein the detent engager is a leaf spring, having a detent engagement end and a base member mounting end.

13. A shift lever assembly according to claim 9, wherein the series of detents are provided on the base member and the detent engager is mounted on the actuator.

14. A shift lever assembly according to claim 12, wherein the movement restriction device includes a lug or arm integrally formed on the shift lever such that, with the shift lever in the manual mode, the lug locates immediately behind the detent engagement end of the leaf spring to prevent the engagement end moving to another detent.

15. A shift lever assembly according to claim 3, including a switching means mounted to the base member for generating an operating signal in response to pivotal movement of the shift lever relative to the base member when in the manual shift mode.

16. A shift lever assembly according to claim 15, wherein the switching means is provided in module form mounted to the base member.

17. A shift lever assembly according to claim 15, wherein the switching means includes an electro-mechanical switch.

18. A shift lever assembly according to claim 12, wherein the detent engagement end includes a roller follower.
